(19) United States
(12) Patent Application Publication
(10) Pub. No.: US 2017/0190159 A1
(43) Pub. Date: Jul. 6, 2017

(54) Packaging Material

(71) Applicant: Graphic Packaging International, Inc., Atlanta, GA (US)

(72) Inventors: Corey Desmond Crooks, Erie, CO (US); Jeffrey T. Sloat, Broomfield, CO (US)

(21) Appl. No.: 15/395,275

(22) Filed: Dec. 30, 2016

Related U.S. Application Data
(60) Provisional application No. 62/273,731, filed on Dec. 31, 2015.
(60) Provisional application No. 62/288,745, filed on Jan. 29, 2016.

(51) Int. Cl. B32B 29/06; B65D 85/00; B32B 3/26; B65D 25/14; B32B 7/12; B32B 29/00

(52) U.S. Cl. CPC B32B 29/06; B32B 7/12; B32B 29/005; B32B 3/26; B65D 25/14; B65D 85/00; B32B 2250/26; B32B 2255/12; B32B 2307/7244; B32B 2307/7246; B32B 2439/70

(57) ABSTRACT

A construct for holding a food product is disclosed. The construct includes at least one wall that at least partially surrounds an interior of the construct. The at least one wall includes a laminate structure that includes a substrate and a composite layer formed of economical-grade parchment. The composite layer is laminated to the substrate with an adhesive such that the composite layer and the adhesive together form a barrier layer. The composite layer has a first porosity, and the barrier layer has a second porosity that is less than the first porosity.

### CROSS-REFERENCE TO RELATED APPLICATIONS

The present application claims the benefit of each of U.S. Provisional Patent Application No. 62/288,745, which was filed on Jan. 29, 2016, and U.S. Provisional Patent Application No. 62/273,731, which was filed on Dec. 31, 2015.

### INCORPORATION BY REFERENCE

The disclosures of each of U.S. Provisional Patent Application No. 62/288,745, which was filed on Jan. 29, 2016, and U.S. Provisional Patent Application No. 62/273,731, which was filed on Dec. 31, 2015, are hereby incorporated by reference for all purposes as if presented herein in its entirety.

### BACKGROUND OF THE DISCLOSURE

The present disclosure generally relates to laminates for forming packaging materials.

### SUMMARY

According to an aspect of the disclosure, a laminate structure for forming a construct for holding a food product is disclosed. The laminate structure includes a substrate and a composite layer adhesively attached to the substrate with an adhesive. The composite layer and the adhesive cooperate to form a barrier layer attached to the substrate. The composite layer has a first porosity, and the barrier layer has a second porosity that is less than the first porosity.

According to an aspect of the disclosure, a construct for holding a food product is disclosed. The construct includes at least one wall that at least partially surrounds an interior of the construct. The at least one wall includes a laminate structure that includes a substrate and a composite layer adhesively attached to the substrate with an adhesive. The composite layer and the adhesive cooperate to form a barrier layer attached to the substrate. The composite layer has a first porosity, and the barrier layer has a second porosity that is less than the first porosity.

According to an aspect of the disclosure, a method of forming a laminate structure is disclosed. The method includes obtaining a substrate and a composite layer. The method also includes laminating the composite layer to the substrate with an adhesive such that the composite layer and the adhesive cooperate to form a barrier layer attached to the substrate. The composite layer has a first porosity, and the barrier layer has a second porosity that is less than the first porosity.

In one aspect, the disclosure is generally directed to a packaging material comprising a laminate. The laminate comprises a substrate and a barrier paper layer. The substrate comprises a degradable and/or repulpable material. The barrier paper layer is glued to the substrate with an adhesive so that the barrier paper layer and the adhesive cooperate to form a barrier. The barrier substantially blocks passage of moisture, oxygen, oils, food products, and/or other substances through the laminate.

Other aspects, features, and details of the present disclosure can be more completely understood by reference to the following detailed description of exemplary embodiment taken in conjunction with the drawings and from the appended claims.

### BRIEF DESCRIPTION OF THE DRAWINGS

Those skilled in the art will appreciate the above stated advantages and other advantages and benefits of various additional embodiments reading the following detailed description of the exemplary embodiments with reference to the below-listed drawing figures. Further, the various features of the drawings discussed below are not necessarily drawn to scale. Dimensions of various features and elements in the drawings may be expanded or reduced to more clearly illustrate the exemplary embodiments of the disclosure.

FIG. 1 is a schematic, parts-separated view of a laminate structure according to an exemplary embodiment of the disclosure.

FIG. 2 is a schematic, perspective view of the assembled laminate structure of FIG. 1.

FIG. 3 is a cross-sectional view taken along section line 3-3 of FIG. 2.

FIG. 4 is a perspective view of a construct formed from the laminate structure of FIG. 1.

Corresponding parts are designated by corresponding reference numbers throughout the drawings.

### DETAILED DESCRIPTION OF EXEMPLARY EMBODIMENTS

The present disclosure generally relates to a packaging material comprising a laminate structure. The packaging material can be for forming a construct (e.g., a container, package, sleeve, tray, plate, bowl, mat, a hingably-closable enclosure, or other constructs). In some embodiments, a packaging material can include other materials in addition to the laminate (e.g., injection-molded polymer elements). The construct, for example, can be used for holding, storing, freezing, heating, cooking, e.g., food products or other products. In one example, a construct can be configured for holding a food product while heating in a microwave oven, a conventional oven, or both (e.g., dual oven heating), for hermetic sealing (e.g., extended life modified atmosphere packaging), for refrigeration/freezing storage, and/or for serving foods (e.g., French fries). Additionally, the packaging material and/or a construct made from the packaging material can include microwave packaging elements (e.g., a microwave susceptor element) and/or seals configured to automatically vent during heating or transportation at high altitude. Other uses and styles of composite constructs are also included in the present disclosure.

In the present embodiment, the materials of the elements of the packaging material can include renewable materials, natural fibers, repulpable materials, and/or degradable materials. For example, renewable materials could be at least partially derived from biological processes or other processes wherein the supply can be replenished in a reasonable time period, which can include annually-renewable plant sources, plant sources that can be renewed in years or decades, algae, bacteria, or any other suitable source. In one example, a reasonable time period for at least partially replenishing a resource can be within an average person's lifetime. A polymer that is derived solely from fossil-based petrochemicals might not be considered a bio-derived polymer, for example. However, some substances that are similar to petrochemicals (e.g., petrochemical analogues) can be produced at least partially by microbes and/or other biological sources or by chemically reacting or modifying bio-sourced materials, for example, and these at least partially bio-derived petrochemical analogues can be used to produce at least partially bio-derived polymers. A natural fiber can be any at least partially naturally-occurring fiber, such as those derived from plants (e.g., wood fibers, cotton, hemp, jute, flax, coir, bamboo, sugarcane, rice husks, banana fiber, ramie, sisal, and other plants). A repulpable material (e.g., paper products) can be a material that can be returned to a pulp (e.g., by chemical, mechanical, and/or other suitable methods) for making a new material from the pulp (e.g., recycled paper). A degradable material (e.g., polylactide-based polymers) could be an at least partially compostable, biodegradable material, and/or other materials that can at least partially break down into small parts that are relatively harmless to the environment and/or into nutrients (e.g., for beneficial plants and/or bacteria) in a reasonable amount of time.

According to one embodiment, renewable and/or degradable materials can include at least partially bio-based polymers, polymers that are at least partially formed from chemicals that are output by or extracted from biological organisms (e.g., plants, algae, bacteria, animals), paper products, and/or other materials. Paperboard and other paper products are often recognized as inherently sustainable or renewable materials as the trees and other plants that provide raw materials for the paper products can be and are routinely replanted in a sustainably renewable fashion. In one embodiment, the renewable and/or degradable material can be processed in injection molding applications, can be bonded or otherwise applied to a substrate (e.g., a blank or a pressed tray), has sealing, barrier, and/or venting properties, and/or has temperature resistance for heating (e.g., microwave and/or conventional oven) and/or for refrigeration/freezing or other storage. Other renewable and/or degradable materials can also be used without departing from the present disclosure.

The materials of the packaging material can have suitable properties for the particular type of construct made from the packaging material. For example, a construct that is a tray or other container for holding or serving a food product can comprise a barrier layer that is permeable or impermeable to certain gases, liquids, and/or other flowable materials (e.g., oils, oxygen, water, food products etc.). A construct for heating a food product can comprise renewable materials with a temperature resistance of at least about 165 degrees Fahrenheit since it is often recommended to heat many food products to at least this temperature. Applications with lower temperature resistance requirements can include, for example, non-food heating, heating beverages, reheating some food items, applications that only require storage and/or cooling, and/or other suitable applications. Some applications can have higher temperature resistance requirements, such as for food products that require a higher external temperature in order to reach a minimum internal temperature, and/or for heating food products at least partially in a conventional oven, which can be set at higher temperatures for heating a food product via conduction and/or convection. Other considerations for selecting a suitable material can include material strength for supporting the weight of a product and/or for stacking.

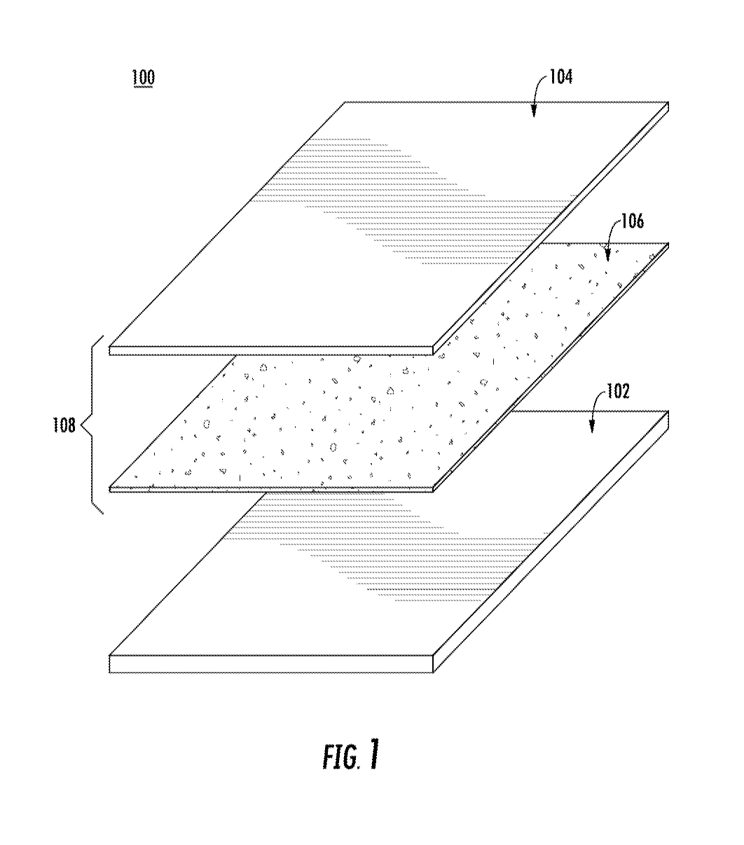

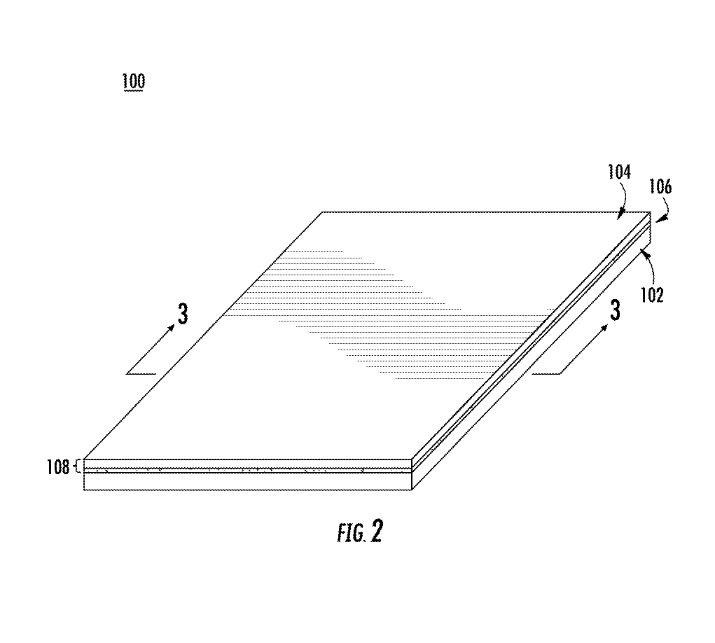

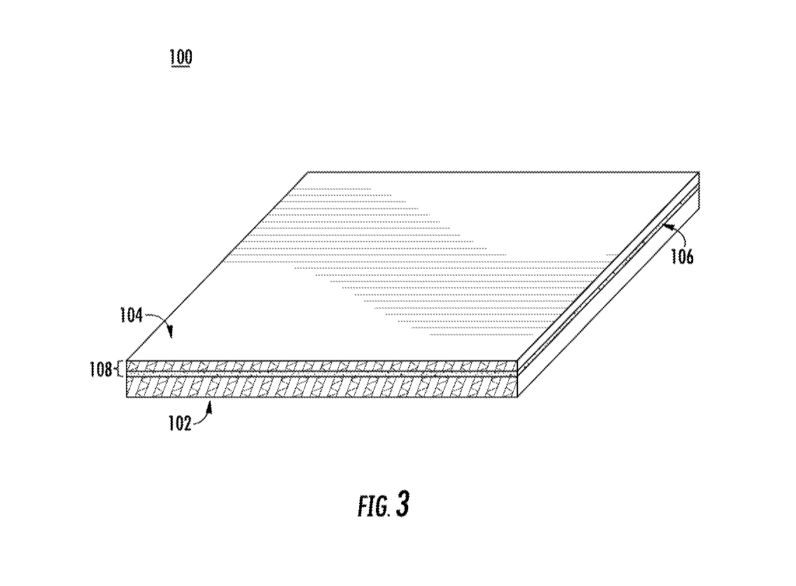

According to an exemplary embodiment illustrated in FIGS. 1-3, the packaging material can comprise a laminate structure 100. The laminate structure 100 can include a substrate 102 and a composite layer 104 that is glued to the substrate 102 by an adhesive 106. The substrate 102 can be a paper product (e.g., paperboard, cardboard, etc.) or any other suitable material (e.g., a material that is degradable, compostable, and/or repulpable). In one embodiment, the composite layer 104 may be a barrier paper, such as parchment paper, formed from a paper material that has been chemically treated to form a film that can be more easily laminated to a substrate. In one embodiment, the parchment paper is commercially available parchment paper suitable for use with (for example, heating) food products. The parchment paper can be made by chemically treating paper pulp with chemicals (e.g., sulfuric acid, zinc chloride, or other suitable material), washing the chemicals off, and drying the treated paper. The chemical treatment of the paper forms a sulfurized cross-linked material with high density, stability, heat resistance, and low surface energy. Depending on the quality or grade of the parchment barrier, the amount of grease resistance or porosity of the parchment paper will vary. High quality and high cost parchment paper will have high grease resistance or low porosity and low quality or low cost parchment paper will have low grease resistance or with high porosity. Alternatively or in addition, the composite layer 104 could include any suitable paper material that has been treated, processed, etc. to have barrier properties (e.g., that can act as an at least partial barrier to water, oil, oxygen, and/or other materials). In the exemplary embodiment illustrated in FIG. 1, composite layer 104 may be formed of a parchment paper that may have an at least partial porosity and/or permeability to the passage of materials therethrough (for example, caused by stray paper fibers, which can act as passageways, and/or other structural aspects of the composite layer 104). Parchment paper and/or other paper products described herein are generally biodegradable, compostable, and repulpable.

In the illustrated embodiment, the adhesive 106 can be a renewable and/or degradable adhesive. In one embodiment, the adhesive 106 is generally degradable, compostable, and/or repulpable with the composite layer 104 and the substrate 102, or, in embodiments, the adhesive 106 may be selected so as to not interfere with the degradability, compostability, and/or repulpability of the composite layer 104 and the substrate 102 so that the laminate structure 100 can be placed in an appropriate waste stream (e.g., landfill, compost, recycling, etc.). For example, the adhesive 106 could be a water-based glue or any other suitable adhesive. In embodiments, the adhesive 106 may be a functional adhesive, e.g., an adhesive that provides properties in addition to bonding between surfaces, for example, adhesion promotion, dispersion of particles, hydrophobicity, hydrophilicity, tensile strength, tear resistance, anti-blocking, and heat resistance or stabilization, to name a few.

In the exemplary embodiment illustrated in FIGS. 1-3, the adhesive 106 can have barrier properties to complement the composite layer 104 so that the adhesive 106 and the composite layer 104 cooperate to form a barrier layer 108 of the laminate structure 100. The barrier layer 108 can be resistant to, e.g., can inhibit, minimize, and/or prevent, the passage of materials, e.g., food products, such as moisture, food grease, oils, oxygen, and/or other substances, for example. In this regard, the adhesive 106 is provided in a complementary relationship with composite layer 104 so as to minimize or eliminate a desired amount of porosity and/or permeability of the composite layer 104 to the passage of materials such as food products. Adhesive 106 may be provided in a pattern or arrangement optimized for the reduction or elimination of the desired amount of porosity or permeability of the composite layer 104. In this regard, the barrier layer 108 formed by the adhesive 106 disposed on the composite layer 104 may have a porosity and/or permeability that is lower than a porosity and/or permeability of the composite layer 104 without the adhesive 106.

In embodiments, the laminate structure 100 can be formed by unrolling the composite layer 104 and the substrate 102 from respective rolls (e.g., in response to the action of one or more nip rollers), applying the adhesive 106 to an inner surface of the substrate 102 and/or the composite layer 104, and nipping the substrate 102, the adhesive 106, and the barrier paper layer 104 with one or more nip rollers (not shown). The laminate structure 100 could be otherwise formed and/or could be otherwise arranged and/or configured without departing from the disclosure. For example, the laminate structure 100 could include additional layers and/or features. In embodiments, the substrate 102 can include supplemental materials, such as coatings that can include clay coatings, colorants, indicia, labels, and the like. In such embodiments, the barrier layer 108 can help minimize, inhibit, and/or prevent food particles such as grease and/or other substances from penetrating to the coatings and/or colorants on the exterior of the laminate structure 100 so that the food grease and/or other substances can be at least partially prevented from discoloring and/or otherwise adversely affecting the exterior of the laminate structure 100.

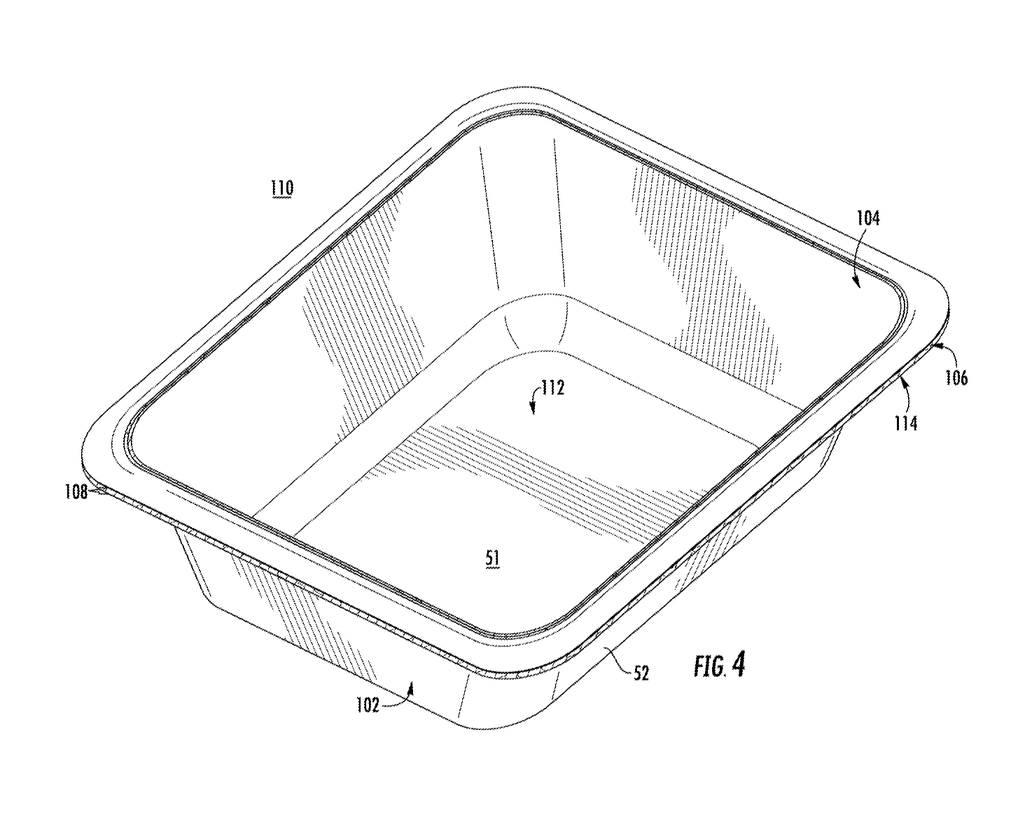

Referring additionally to FIG. 4, a construct 110 may be formed from the laminate structure 100, for example, by at least partially folding the laminate structure 100 to define an interior 112 of the construct 110. In this regard, the construct 110 includes at least one wall 114 formed from the laminate structure 110 such that the composite layer 104 defines an interior-facing, e.g., food-contacting, surface Si of the container 110 and the substrate 102 forms an exterior surface S2 of the construct 110. In embodiments, construct 110 may be formed from the laminate structure 100 by press-forming, e.g., with a pressing block and cavity.

In this regard, the barrier layer 108 is provided such that the arrangement of the adhesive 106 relative to the composite layer 104 reduces and/or minimizes a porosity and/or permeability of the composite layer 104. In embodiments, a minimized thickness or number of layers, e.g., a single layer, may be selected for composite layer 104 owing to the additional presence of the adhesive 106 in the barrier layer 108. Accordingly, materials such as economical-grade parchment can be selected for the composite layer 104 while maintaining an effective barrier to passage of materials, e.g., food particles such as grease, therethrough. As such, the laminate structure 100 and construct 110 disclosed herein provide an effective, cost-efficient alternative to the use of laminate structures that incorporate barriers formed of, for example, polyethylene (PE) or multi-layered materials. Additionally, the disclosed laminate structure 100 and construct 110 provide a configuration that is degradable (e.g., biodegradable), compostable, and/or repulpable as compared to conventional laminate structures and constructs, for example, those containing polyethylene (PE).

According to one embodiment, the packaging material includes multiple layers, each comprising materials that are derived from up to 100 percent renewable sources and/or degradable (e.g., biodegradable) materials. Accordingly, the packaging material can have little or no strain on non-renewable resources and the use of renewable and/or degradable materials can be advertised to a consumer. Additionally, the present disclosure is directed to using renewable and/or degradable materials in a construct with the advantages of a laminate, including those that use paper or paperboard for enhanced package graphics and stiffness at elevated cooking temperatures, with a barrier layer for reducing permeability to certain substances with the added benefits of being suitable for alternative waste streams (e.g., composting, recycling, etc.).

In accordance with exemplary embodiments, the packaging material can be incorporated into blanks for forming respective constructs (e.g., trays, cartons, fast food containers, etc.). In such embodiments, the substrate can be formed from paperboard, corrugated cardboard or other materials having properties suitable for at least generally enabling respective functionalities described above. Paperboard can be of a caliper such that it is heavier and more rigid than ordinary paper, and corrugated cardboard can be of a caliper such that it is heavier and more rigid than paperboard. Generally, at least the side of the paperboard or cardboard that will be an exterior surface in the construct erected therefrom will be coated with a clay coating, or the like. The clay coating can be printed over with product, advertising, price-coding, and other information or images. The blanks may then be coated with a varnish to protect any information printed on the blanks. The blanks may also be coated with, for example, a moisture barrier layer, on one or both sides. The blanks can also be laminated to or coated with one or more sheet-like materials.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A laminate structure for forming a construct for holding a food product, the laminate comprising:
a substrate; and
a composite layer adhesively attached to the substrate with an adhesive, the composite layer and the adhesive cooperate to form a barrier layer attached to the substrate, the composite layer having a first porosity, the barrier layer having a second porosity being less than the first porosity.

2. The laminate structure of claim 1, wherein the composite layer comprises parchment paper.

3. The laminate structure of claim 2, wherein the adhesive is a functional adhesive.

4. The laminate structure of claim 2, wherein the adhesive has a property selected from the group consisting of: renewable, degradable, and water-based.

5. The laminate structure of claim 4, wherein the composite layer has a property selected from the group consisting of: degradable, compostable, and repulpable.

6. The laminate structure of claim 5, wherein the substrate has a property selected from the group consisting of: degradable, compostable, and repulpable.

7. The laminate structure of claim 1, wherein the construct is configured to be disposed in a waste stream selected from the group consisting of: landfills, compost, and recycling.

8. The laminate structure of claim 1, wherein the composite layer comprises a single material.

9. The laminate structure of claim 1, wherein the composite layer comprises a multi-layer material.

10. The laminate structure of claim 1, wherein a surface of the substrate forms an exterior surface of the construct.

11. The laminate structure of claim 1, wherein a surface of the composite layer forms a food-contacting surface of the construct.

12. The laminate structure of claim 1, wherein the adhesive completely covers a surface of the composite layer facing the substrate.

13. A construct for holding a food product, comprising:
at least one wall at least partially surrounding an interior of the construct, the at least one wall comprising a laminate structure that comprises:
a substrate; and
a composite layer adhesively attached to the substrate with an adhesive, the composite layer and the adhesive cooperate to form a barrier layer attached to the substrate, the composite layer having a first porosity, the barrier layer having a second porosity being less than the first porosity.

14. The construct of claim 13, wherein the composite layer comprises parchment paper.

15. The construct of claim 14, wherein the adhesive is a functional adhesive.

16. The construct of claim 14, wherein the adhesive has a property selected from the group consisting of: renewable, degradable, and water-based.

17. The construct of claim 16, wherein the composite layer has a property selected from the group consisting of: degradable, compostable, and repulpable.

18. The construct of claim 17, wherein the substrate has a property selected from the group consisting of: degradable, compostable, and repulpable.

19. The construct of claim 13, wherein the construct is configured to be disposed in a waste stream selected from the group consisting of: landfills, compost, and recycling.

20. The construct of claim 13, wherein the composite layer comprises a single material.

21. The construct of claim 13, wherein the composite layer comprises a multi-layer material.

22. The construct of claim 13, wherein a surface of the substrate forms an exterior surface of the construct.

23. The construct of claim 13, wherein a surface of the composite layer forms a food-contacting surface of the construct.

24. The construct of claim 13, wherein the adhesive completely covers a surface of the composite layer facing the substrate.

25. A method of forming a laminate structure, comprising:
obtaining a substrate and a composite layer;
laminating the composite layer to the substrate with an adhesive such that the composite layer and the adhesive cooperate to form a barrier layer attached to the substrate, the composite layer having a first porosity, the barrier layer having a second porosity being less than the first porosity.

26. The method of claim 25, wherein the composite layer comprises parchment paper.

27. The method of claim 26, wherein the adhesive is a functional adhesive.

28. The method of claim 26, wherein the adhesive has a property selected from the group consisting of: renewable, degradable, and water-based.

29. The method of claim 28, wherein the composite layer has a property selected from the group consisting of: degradable, compostable, and repulpable.

30. The method of claim 29, wherein the substrate has a property selected from the group consisting of: degradable, compostable, and repulpable.

31. The method of claim 25, wherein the laminate structure is configured to be disposed in a waste stream selected from the group consisting of: landfills, compost, and recycling.

32. The method of claim 25, wherein the composite layer comprises a single material.

33. The method of claim 25, wherein the composite layer comprises a multi-layer material.

34. The method of claim 25, wherein a surface of the substrate forms an exterior surface of the laminate structure.

35. The method of claim 25, wherein a surface of the composite layer forms a food-contacting surface of the laminate structure.

36. The method of claim 25, wherein the adhesive completely covers a surface of the composite layer facing the substrate.
